(19) United States
(12) Patent Application Publication
(10) Pub. No.: US 2016/0131474 A1
(43) Pub. Date: May 12, 2016

(54) NON-CONTACT SURFACE-SHAPE MEASURMENT METHOD AND APPARATUS USING WHITE LIGHT INTERFEROMETER OPTICAL HEAD

(71) Applicant: MITUTOYO CORPORATION, Kanagawa (JP)

(72) Inventors: Takeshi SAEKI, Kunitachi (JP); Yutaka WATANABE, Kawasaki (JP); Takuho MAEDA, Kawasaki (JP)

(73) Assignee: MITUTOYO CORPORATION, Kanagawa (JP)

(21) Appl. No.: 14/928,252

(22) Filed: Oct. 30, 2015

(30) Foreign Application Priority Data
Nov. 10, 2014 (JP) 2014-228465

(51) Int. Cl. G01B 11/24; G01B 9/02

(52) U.S. Cl. CPC G01B 11/24; G01B 9/02034

(57) ABSTRACT

A non-contact surface-shape measuring method uses a white light interferometer optical head that divides, through a beam splitter, light emitted from a white light source into reference light for a reference mirror and measurement light for a measured object surface; obtains an image having interference fringes generated from an optical path difference of light reflecting from the reference mirror and light reflecting from the measured object surface; and is displaced for scanning in a vertical direction with respect to the measured object surface in order to obtain the image having interference fringes. While the white light interferometer optical head is displaced in a scanning direction, a position of the optical head in the scanning direction is detected, and the image having interference fringes is obtained at predetermined spatial intervals in the scanning direction.

### CROSS-REFERENCE TO RELATED APPLICATIONS

The present application claims priority under 35 U.S.C. §119 of Japanese Application No. 2014-228465, filed on Nov. 10, 2014, the disclosure of which is expressly incorporated by reference herein in its entirety.

### BACKGROUND OF THE INVENTION

1. Field of the Invention

The present invention relates to non-contact surface-shape measurement method and apparatus using a white light interferometer optical head. Especially, the present invention is related to a non-contact surface-shape measurement method and apparatus using a white light interferometer optical head which can perform measurement with a high degree of accuracy, suitable to be used for image measuring devices and measurement microscopes.

2. Description of Related Art

As shown in FIG. 1 illustrating a primary configuration, in a non-contact surface-shape measurement using a white light interferometer optical head 10 (as discussed in Japanese Patent Laid-open Publication No. H06-001167 and Japanese Patent No. 3,220,955), light emitted from a white light source 12 is divided, by a beam splitter 16 and a half mirror, into reference light for a reference mirror 20 and measurement light for a measured object surface (i.e., surface of a measured work piece W). Then, an image showing interference fringes, generated by an optical path difference of light reflecting from the reference mirror 20 and light reflecting from the measured object surface, is measured by a camera 26 including a photodetector array. Accordingly, an uneven shape of the measured work piece W and the like is measured based on an intensity of the interference fringes. FIG. 1 includes a collimating lens 14, interference objective lenses 18 and 22, and an imaging lens 24.

When the white light interferometer optical head (hereafter referred to simply as optical head) 10 is displaced in a vertical direction to scan the surface of the measured work piece W, interference fringes appear in an area centering around where the optical path difference between the reference light and the measurement light becomes zero. A photodetector of the camera 26 detects a peak location of the intensity of the interference fringes, thereby obtaining a three dimensional surface shape (hereafter referred to simply as three dimensional shape) of the measured work piece W. In order to obtain a more accurate three dimensional shape, it is preferred that the image showing the interference fringes obtained by displacing the optical head 10 for scanning is obtained with a constant spacial pitch with accuracy, in the scanning direction.

However, in the non-contact surface-shape measurement using the conventional white light interferometer optical head, an image is obtained with a constant temporal pitch through a frame rate of the camera. Specifically, in a time sampling method as shown in FIG. 2, (1) based on an event in which a vertical synchronization signal in a video signal, which is output from the camera 26 in a frame rate of 200 Hz, for example, during scanning, (2) image data obtained by a frame grabber 28 is transmitted to a personal computer (PC) 30. At the same time, (2′) the frame grabber 28 notifies the PC 30 of reception of the video signal, and (2″) software 30A inside the PC 30 generates a position latch signal having a constant temporal pitch (as shown in the left side of FIG. 3) and responds to the frame grabber 28. (3) The frame grabber 28 transmits the position latch signal to a motion controller 32, and (4) the motion controller 32 transmits position data to the PC 30. (5) Thereby, an image corresponding to the position data is collected through the time sampling method.

However, with the time sampling method as discussed above, a spatial pitch for an image capturing position is not always constant due to speed changes in a Z axis (caused by, for example, speed changes during acceleration/deceleration, or speed rippling during a low speed movement). Therefore, a degree of measurement accuracy becomes lower. Especially, when a servo motor is used for displacing the camera 26, the displacement speed varies as shown in the left side of FIG. 3, in which the acceleration/deceleration speed is lower in the beginning and end of the displacement. Therefore, in the image obtainment through the constant temporal pitch, it becomes difficult to perform accurate image obtainment with a constant spatial pitch. As a result, as shown in the example in the right side of FIG. 3, with a high sampling rate and a low acceleration/deceleration speed in a system, an image is obtained without much displacement in the Z axis in the beginning and end of the displacement. Therefore, not only is unnecessary processing performed, but malfunctioning is caused in a later stage of the process, thereby degrading the measurement accuracy.

In Japanese Patent Laid-open Publication No. H6-001167, it is suggested to control an operation by detecting an image capturing position. However, there is no discussion of capturing an image at identical spatial intervals.

Further, Japanese Patent No. 3,220,955 discusses varying a position of the reference mirror with a constant pitch, using a piezo-electric element (PZT). However, piezo-electric elements have a small scanning range and poor position determination accuracy. Therefore, accurate spatial pitch sampling in a wide range becomes difficult.

### SUMMARY OF THE INVENTION

The present invention is provided to address the above-described conventional issues. The present invention provides an improved measurement accuracy when there is a large speed fluctuation, especially when driving a servo motor, for example, which makes it difficult to perform image acquisition having an accurate constant spatial pitch during image acquisition through a constant temporal pitch.

A non-contact surface-shape measuring method according to the present invention uses a white light interferometer optical head that divides, through a beam splitter, light emitted from a white light source into reference light for a reference mirror and measurement light for a measured object surface; obtains an image having interference fringes generated from an optical path difference of light reflecting from the reference mirror and light reflecting from the measured object surface; and is displaced for scanning in a vertical direction with respect to the measured object surface in order to obtain the image having interference fringes. While the white light interferometer optical head is displaced in a scanning direction, a position of the optical head in the scanning direction is detected, and the image having interference fringes is obtained at predetermined spatial intervals in the scanning direction.

According to the present invention, a non-contact surface-shape measuring apparatus uses a white light interferometer optical head that divides, through a beam splitter, light emitted from a white light source into reference light for a reference mirror and measurement light for a measured object surface, and obtains an image having interference fringes generated from an optical path difference of light reflecting from the reference mirror and light reflecting from the measured object surface. The apparatus displaces the white light interferometer optical head for scanning in a vertical direction with respect to the measured object surface in order to obtain the image having interference fringes. The apparatus includes: a driver that displaces the white light interferometer optical head in a scanning direction; an encoder that detects a position, in the scanning direction, of the white light interferometer optical head; and a motion controller that instructs, through a trigger signal output from the encoder at predetermined spatial intervals, the white light interferometer optical head to obtain the image having interference fringes.

According to the present invention, it is possible to provide a highly accurate measurement and effective processing, and to improve reliability, through an accurate spatial sampling, even when a white light interferometer optical head is driven by a driver such as a servo motor having a large speed fluctuation even though the driving range may be wide.

### BRIEF DESCRIPTION OF THE DRAWINGS

The present invention is further described in the detailed description which follows, in reference to the noted plurality of drawings by way of non-limiting examples of exemplary embodiments of the present invention, in which like reference numerals represent similar parts throughout the several views of the drawings, and wherein:

FIG. 1 illustrates a configuration of relevant portions of a non-contact surface-shape measurement apparatus using a white light interferometer optical head;

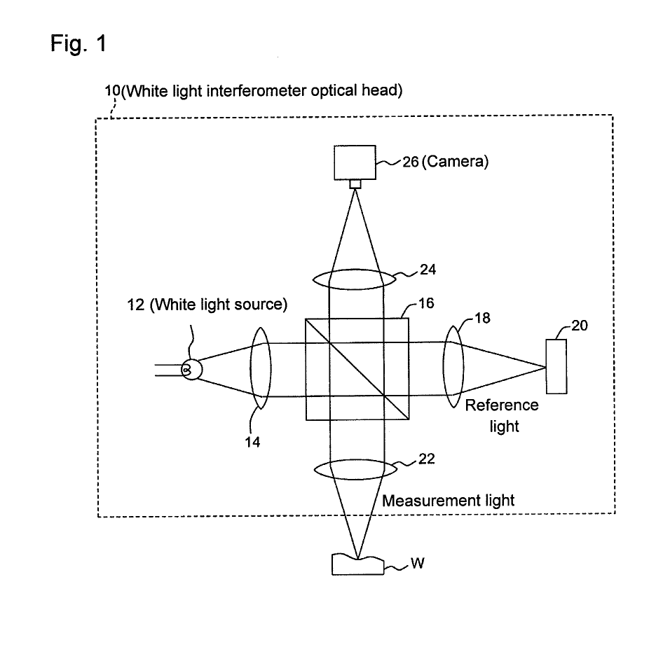

FIG. 2 is a block diagram illustrating a configuration using a conventional time sampling method;

FIG. 3 illustrates a problem in the conventional method;

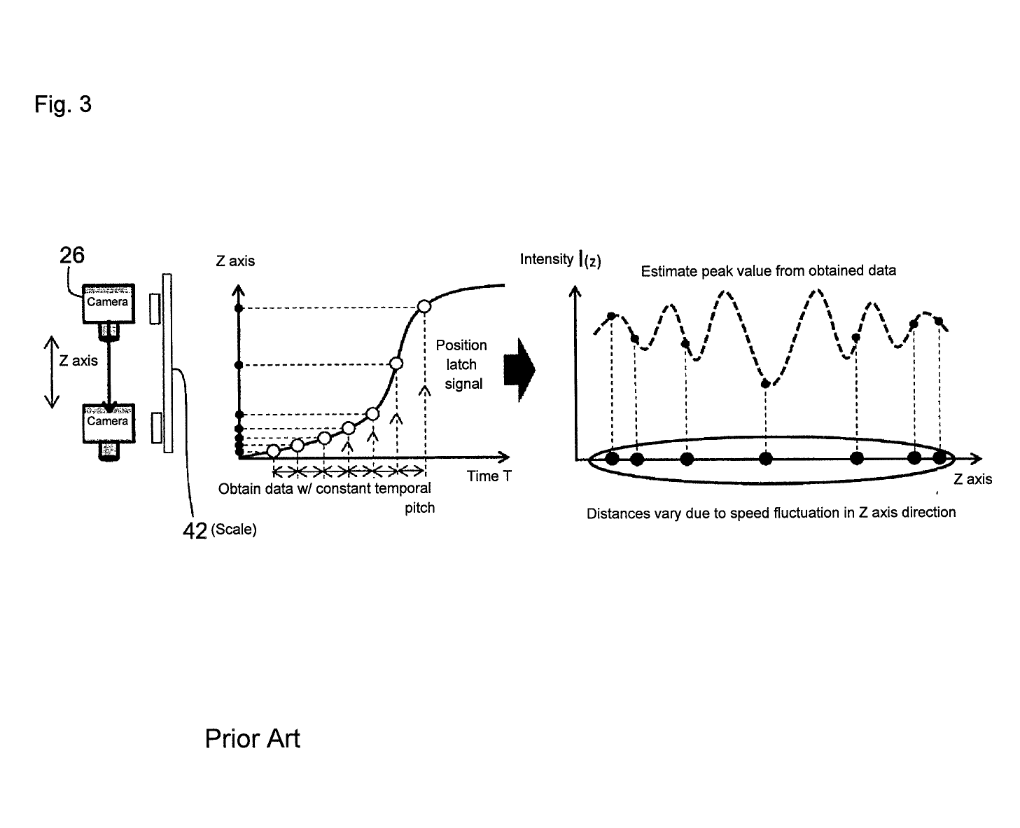

FIG. 4 is a block diagram illustrating a configuration according to an embodiment of the present invention;

FIG. 5 illustrates an action according to the embodiment of the present invention;

FIG. 6 illustrates a modified example of the optical head; and

FIG. 7 illustrates another modified example of the optical head.

### DETAILED DESCRIPTION OF THE INVENTION

The particulars shown herein are by way of example and for purposes of illustrative discussion of the embodiments of the present invention only and are presented in the cause of providing what is believed to be the most useful and readily understood description of the principles and conceptual aspects of the present invention. In this regard, no attempt is made to show structural details of the present invention in more detail than is necessary for the fundamental understanding of the present invention, the description taken with the drawings making apparent to those skilled in the art how the forms of the present invention may be embodied in practice.

Below is a detailed explanation of an embodiment of the present invention referencing the drawings. The present invention is not limited to the contents written in the embodiment and examples below. Configuration requirements in the following embodiment and examples may also include that which is readily conceivable by one skilled in the art, that which is substantially similar, and that which encompasses an equivalent scope. Furthermore, the configuration requirements disclosed in the following embodiment and examples may be combined as appropriate, or may be selectively employed as appropriate.

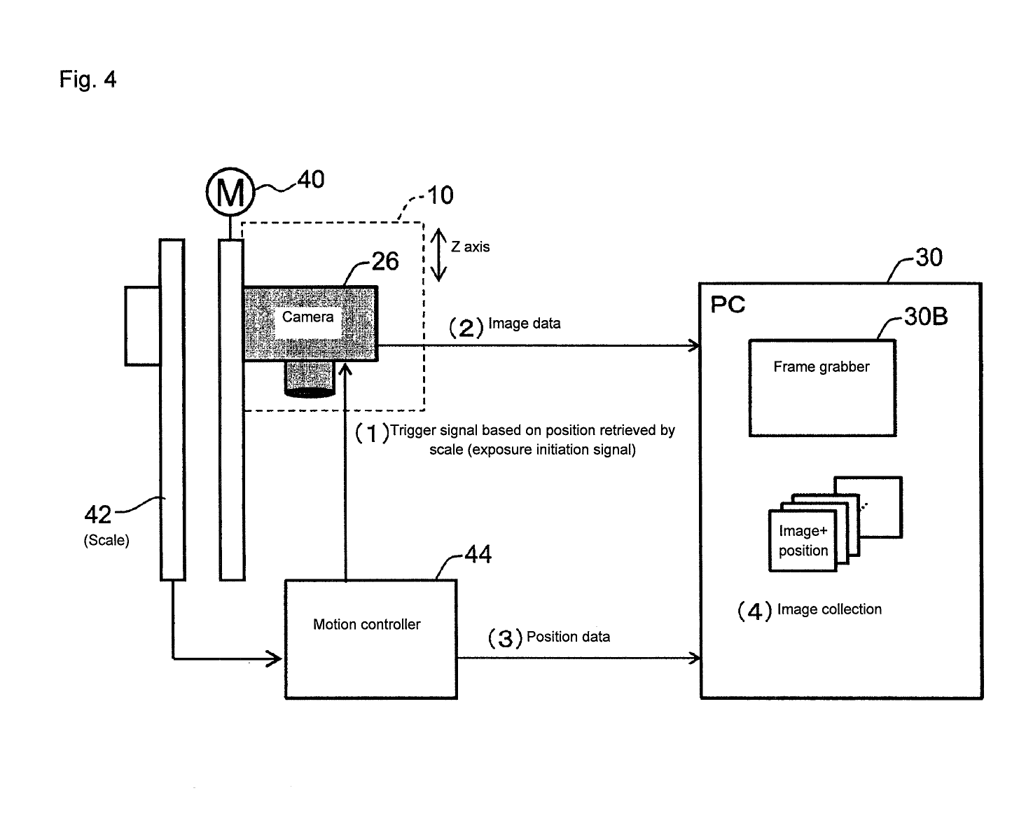

According to the embodiment of the present invention, as shown in FIG. 4, a non-contact surface-shape measurement apparatus using a white light interferometer optical head includes: a servo motor 40 that displaces a camera 26 in a scanning direction (a vertical Z axis direction in FIG. 4); a linear encoder (hereafter referred to as scale) 42 that detects a position, in the scanning direction, of the optical head including the camera 26; and a motion controller 44 that starts exposure by sending a trigger signal to the camera 26 according to a camera position detected by the scale 42 and adds position data to image data captured by a frame grabber 30B within a PC 30.

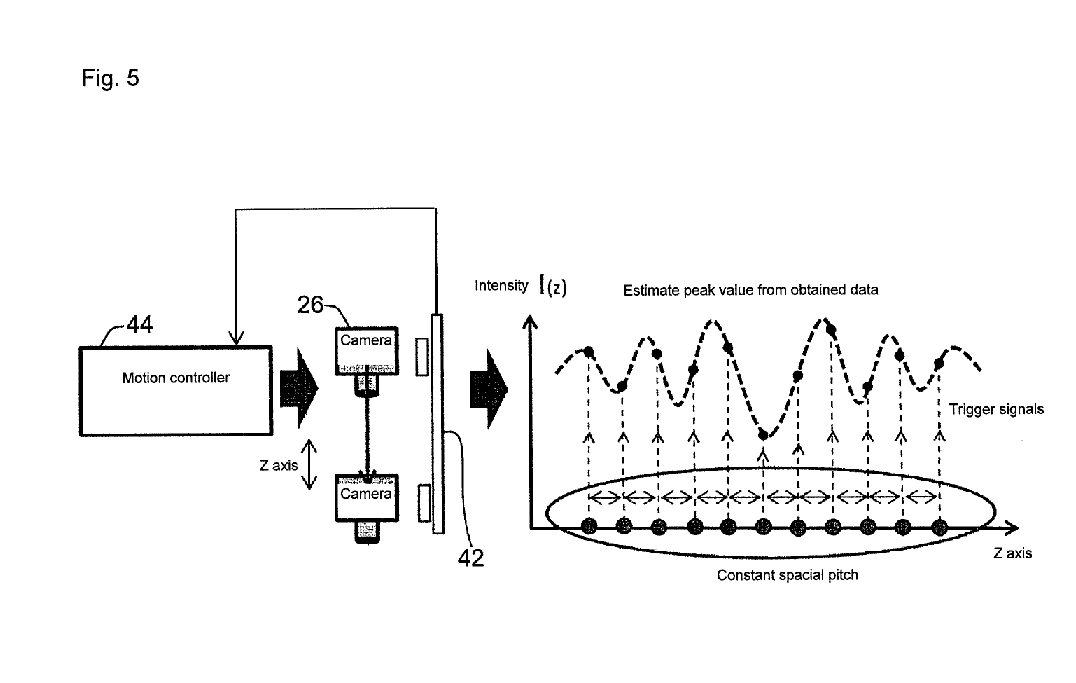

Upon measuring, as shown in an example in the left side of FIG. 5, as the servo motor 40 displaces the camera 26 in the Z axis direction (for scanning), the scale 42 detects a position of the camera 26 in the Z-axis direction. (1) When the camera 26 reaches a predetermined position for obtaining an image, the motion controller 44 transmits a trigger signal to the camera 26 and starts exposure. After the exposure, (2) the camera 26 transmits the image data to the PC 30, and the frame grabber 30B within the PC 30 obtains the image. (3) At the same time, position data for when the trigger signal is generated (obtained from the motion controller 44) is captured by the PC 30, and (4) is added to the image data obtained by the frame grabber 30B to generate a collected image.

In the present embodiment, the camera 26 is instructed to capture an image when the camera arrives at a predetermined position for image capturing through area sampling, instead of time sampling. Therefore, as shown in the right side of FIG. 5, unwanted sampling data is not generated, thereby enabling effective processing and improving measurement accuracy.

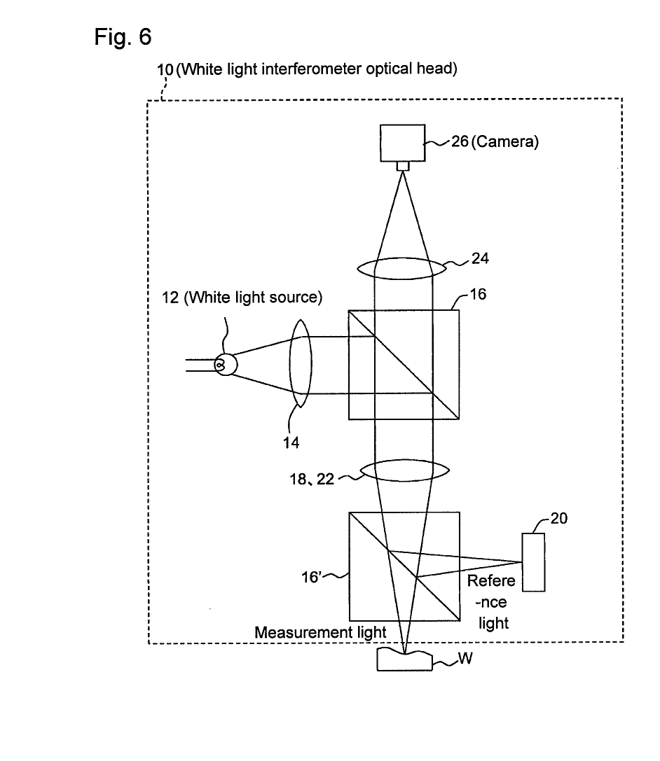

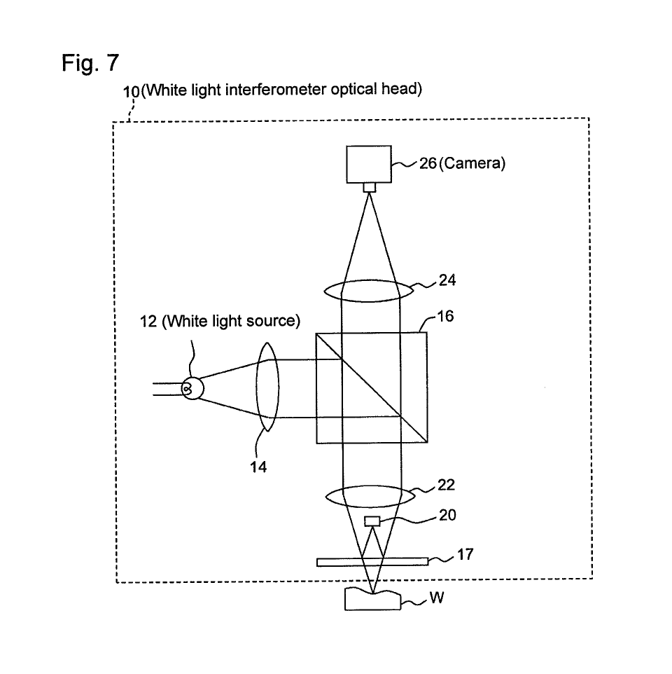

Further, in the embodiment described above, two interference objective lenses 18 and 22 (for reference light and measurement light) are used in the optical head 10. However, the configuration of the optical head 10 is not limited to this. For example, in a modified example shown in FIG. 6, a beam splitter 16′ may be added to employ one lens as the interference objective lenses 18 and 22. In addition, in another modified example shown in FIG. 7, a half mirror 17 and a reference mirror 20 may be arranged between a measured work piece W and the interference objective lens 22, or a collimating lens may be omitted to utilize diverging/converging light.

A driver is not limited to the servo motor 40, and other motors, piezo-electric devices, voice coils, or the like may be used instead.

Further, the encoder is not limited to the scale 42, and a rotary encoder detecting a rotation position of the servo motor 40 may be used, for example.

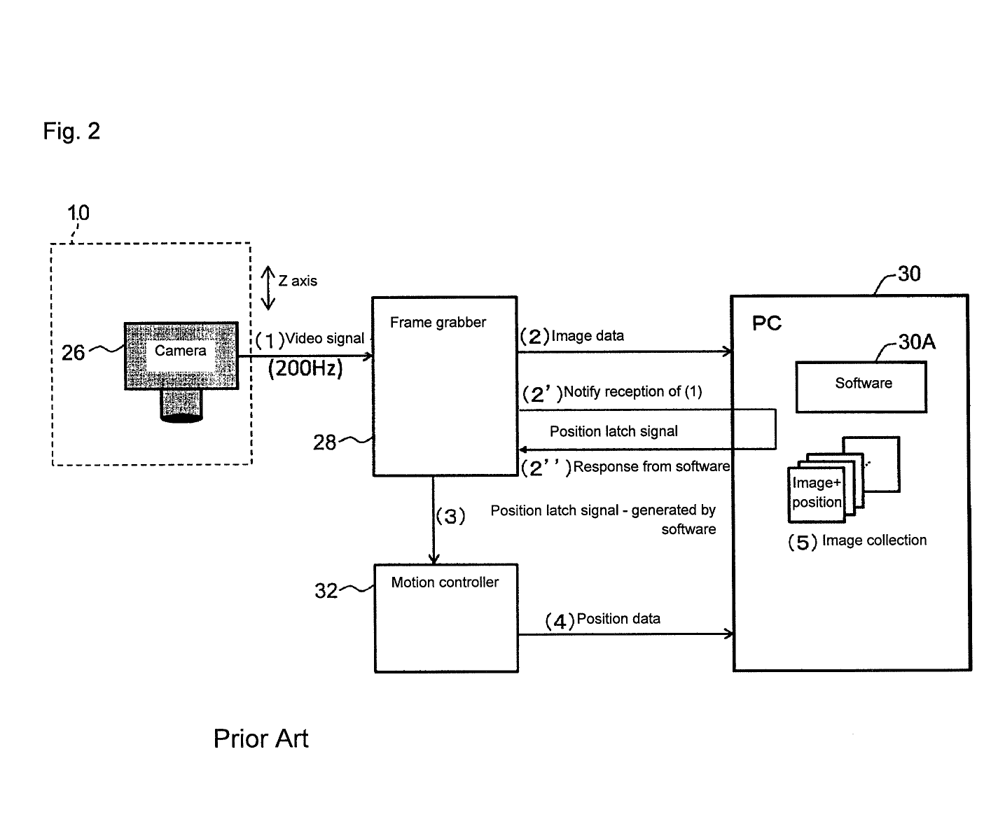

It is not necessary for the frame grabber to be within the PC 30, and the frame grabber may be between the camera 26 and the PC 30 as shown in the example in FIG. 2.

Further, the embodiment described above illustrated an example where a configuration has an image measuring device as a base. However, the principle of the present invention may be applicable to other measuring microscopes and interferometer microscopes, including Michelson, Mirau, and Linnik interferometer microscopes.

It is noted that the foregoing examples have been provided merely for the purpose of explanation and are in no way to be construed as limiting of the present invention. While the present invention has been described with reference to exemplary embodiments, it is understood that the words which have been used herein are words of description and illustration, rather than words of limitation. Changes may be made, within the purview of the appended claims, as presently stated and as amended, without departing from the scope and spirit of the present invention in its aspects. Although the present invention has been described herein with reference to particular structures, materials and embodiments, the present invention is not intended to be limited to the particulars disclosed herein; rather, the present invention extends to all functionally equivalent structures, methods and uses, such as are within the scope of the appended claims.

The present invention is not limited to the above described embodiments, and various variations and modifications may be possible without departing from the scope of the present invention.

What is claimed is:

1. A non-contact surface-shape measuring method using a white light interferometer optical head that divides, through a beam splitter, light emitted from a white light source into reference light for a reference mirror and measurement light for a measured object surface; obtains an image having interference fringes generated from an optical path difference of light reflecting from the reference mirror and light reflecting from the measured object surface; and is displaced for scanning in a vertical direction with respect to the measured object surface in order to obtain an image having interference fringes, the method comprising:
detecting a position of the optical head in the scanning direction, while displacing the white light interferometer optical head in a scanning direction; and
obtaining the image having interference fringes at predetermined spatial intervals in the scanning direction.

2. A non-contact surface-shape measuring apparatus using a white light interferometer optical head that divides, through a beam splitter, light emitted from a white light source into reference light for a reference mirror and measurement light for a measured object surface, and obtains an image having interference fringes generated from an optical path difference of light reflecting from the reference mirror and light reflecting from the measured object surface, the apparatus displacing the white light interferometer optical head for scanning in a vertical direction with respect to the measured object surface in order to obtain an image having interference fringes, the apparatus comprising:
a driver configured to displace the white light interferometer optical head in a scanning direction;
an encoder configured to detect a position, in the scanning direction, of the white light interferometer optical head; and
a motion controller configured to instruct, through a trigger signal output from the encoder at predetermined spatial intervals, the white light interferometer optical head to obtain the image having interference fringes.
